(19) United States
(12) Patent Application Publication
(10) Pub. No.: US 2026/0254392 A1
(43) Pub. Date: Aug. 27, 2026

(54) ELECTRIC MOTOR DRIVE AND INTEGRATED MARINE ELECTRIC SYNCHRONOUS MOTOR

(71) Applicant: Danfoss Power Electronics A/S, Grästen (DK)

(72) Inventor: Asgeir FARSTAD, Horten (NO)

(21) Appl. No.: 19/543,973

(22) Filed: Feb. 19, 2026

(30) Foreign Application Priority Data
Feb. 24, 2025 (DE) 102025106896.8

(51) Int. Cl. H02P 29/028

(52) U.S. Cl. CPC H02P 29/028

(57) ABSTRACT

The present disclosure relates to a protection system for synchronous generators or motors used in power converter arrangements, particularly in marine applications. The system provides enhanced fault isolation, redundancy, and operational safety for electrical propulsion and power generation systems. More specifically, the disclosure addresses the need for selective fault isolation in power converters, ensuring that failures do not lead to total system shutdown. The disclosure is also directed at a power system including a protection system.

### CROSS-REFERENCE TO RELATED APPLICATIONS

This application claims foreign priority benefits under 35 U.S.C. § 119 to German Patent Application No. 102025106896.8 filed on Feb. 24, 2025, the content of which is hereby incorporated by reference in its entirety.

### TECHNICAL FIELD

The present invention relates to a protection system for synchronous generators or motors used in power converter arrangements, particularly in marine applications. The system provides enhanced fault isolation, redundancy, and operational safety for electrical propulsion and power generation systems. More specifically, the invention addresses the need for selective fault isolation in power converters, ensuring that failures do not lead to total system shutdown. The inventions is also directed at a power system comprising a protection system.

### BACKGROUND

Marine electric propulsion and power generation systems require robust protection mechanisms to ensure reliable operation under various load conditions. Conventional protection systems often rely on single-point disconnection devices, which can lead to complete system shutdown in the event of a fault. The present invention introduces a modular and scalable protection system that enables selective isolation of faulty components while maintaining system functionality. This is particularly critical in marine applications where continuous operation is essential, and downtime can lead to significant economic and operational losses.

Traditional fault protection mechanisms utilize single large fuses or circuit breakers, which are often designed to handle the total current of the motor drive system. However, these solutions present several challenges:

Known protection systems typically lack of redundancy as a single fuse or circuit breaker means that when a fault occurs, the entire system is taken offline, rather than isolating only the affected components and maintaining system operation.

The large protective components of known protection systems tend to be expensive and contribute significantly to system weight, which is a crucial factor in marine and industrial applications.

Fixed frequency and current ratings in standard protective components do not allow for flexible operation under variable load conditions, permitting only limited adaptability of the known protection systems.

### SUMMARY

The aim of the present invention is to overcome these limitations by incorporating multiple, independently operable protection devices that offer a balance between redundancy, cost efficiency, and operational flexibility.

This aim is achieved by a protection system according to claim 1 and a power system according to claim 17 and comprising a protection system. Advantageous embodiments of the invention are subject to the dependent claims.

According to claim 1, a protection system for a synchronous generator or motor in a power converter arrangement is provided. The system comprises a controller and at least two converters, further comprising:
a plurality of circuit disconnection devices, each configured to interrupt the power supply to one converter,
a fault detection device, such as a current sensor and/or or fuses, for detecting faults of the converters,
wherein the controller triggers a remote open signal to at least one of the circuit disconnection devices for interrupting the power supply to a converter upon detection of a fault condition, wherein each disconnection device operates independently to interrupt the power supply of a faulty converter, enabling continued operation of the remaining converters.

The invention provides a protection system for a synchronous generator or motor in a power converter arrangement. The system includes multiple circuit disconnection devices configured to provide individual electrical isolation of any faulty converter, ensuring that faults in one converter do not impact the operation of other converters. The system incorporates a remote open signal, which is triggered upon detection of a fault condition, allowing for selective isolation of faulty components.

In a preferred embodiment of the invention, the protection system further comprises a plurality of fuses, each associated with a respective circuit disconnection device, the fuses being configured to provide cascading backup protection specifically for fault conditions where the operational frequency is outside the rated range of the circuit disconnection devices.

In another embodiment of the invention, the fuses and circuit disconnection devices are configured to provide fault protection for frequencies other than the standard 50/60 Hz, enabling effective protection in applications with non-standard synchronous generator or motor frequencies.

The plurality of fuses associated with the circuit disconnection devices offer cascading backup protection. These fuses are specifically designed to handle frequencies outside the standard 50/60 Hz range, making the system suitable for applications with non-standard synchronous generator or motor frequencies.

In another embodiment of the invention, the individual isolation of converters facilitates enhanced redundancy by allowing the system to continue operation with unaffected converters when a fault is detected and a converter is isolated.

According to another embodiment of the invention, the fuses and circuit disconnection devices are sized and selected to optimize protection for systems with limited short circuit power supply availability, reducing the risk of overloading protection devices.

To further enhance system efficiency, the fuses and disconnection devices are selected based on system requirements to ensure optimized fault protection, particularly in environments with limited short-circuit power supply availability. This ensures that each individual converter is protected at a relative lower tripping limit setpoint to provide enhanced protection.

In another preferred embodiment of the invention, the operational frequency range of the circuit disconnection devices is dynamically adjustable to accommodate varying load or generator conditions.

In another preferred embodiment of the invention, the remote open signal prioritizes isolation of converters based on severity or type of fault.

The system is hence able to operate dynamically, adjusting its protection settings based on real-time load conditions. The remote open signal prioritizes isolation of converters based on the severity or type of fault, ensuring that minor faults do not unnecessarily trigger full system shutdowns.

In another preferred embodiment of the invention, the circuit disconnection devices and/or fuses are designed as modular units, allowing scalable protection for systems with varying numbers of converters. A corresponding module may comprise one circuit disconnection device and/or one fuse and may be provided such that it can be easily exchanged for a defective module.

In another preferred embodiment of the invention, the fuses include temperature-sensitive elements to enhance protection under varying thermal conditions.

In another preferred embodiment of the invention, the system comprises an integrated diagnostic monitoring system to identify, log, and report fault conditions and isolation events.

In another preferred embodiment of the invention, the fuses are rated for a lower current than the summary synchronous generator or motor current.

In another preferred embodiment of the invention, the circuit disconnection devices are rated for a lower current than the summary synchronous generator or motor current.

In another preferred embodiment of the invention, the fuses are faster to interrupt the current than one single fuse to lead the total current would be.

In another preferred embodiment of the invention, the switches are rated for the high frequency switching used by the inverter to drive the motor.

In another preferred embodiment of the invention, the circuit disconnection devices and/or fuses are cheaper to use than a system with a single switch and/or a single fuse. The circuit disconnection devices and/or fuses may preferably be marine class components.

The invention is also directed at a power system comprising: a bi-directional DC-link configured to facilitate power transfer between a power supply and a load, a protection system, wherein the protection system ensures safe operation of the DC-link during fault conditions.

The protection system may comprise any features of the presently described protection system.

### BRIEF DESCRIPTION OF THE DRAWINGS

Further details and advantages are described with reference to the figures. The figures show:

FIG. 1: circuit diagram of main configuration of the protection system;

FIG. 2: schematic diagram of power converter arrangement according to the state of the art; and

FIG. 3: schematic diagram of power converter arrangement according to the present invention.

### DETAILED DESCRIPTION

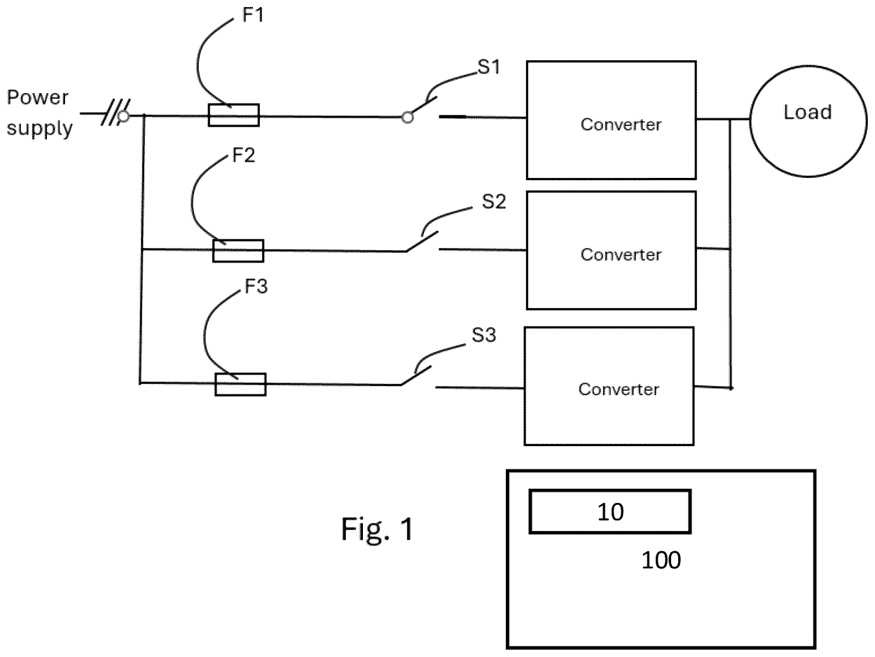

FIG. 1 illustrates the main configuration of the present invention's protection system, including the placement of circuit disconnection devices S1, S2, S3, fuses F1, F2, F3, and the remote open signal system.

The protection system comprises a series of independently operable circuit disconnection devices S1, S2, S3 that provide selective isolation of a faulty converter. Each circuit disconnection device S1, S2, S3 is associated in series with a fuse F1, F2, F3 and a converter to ensure comprehensive fault protection. The system operates by detecting fault conditions and triggering a remote open signal to the corresponding circuit disconnection device S1, S2, S3, which prioritizes isolation of the affected converter based on severity or fault type. In the present embodiment, three branches of circuit disconnection device S1, S2, S3 and associated fuses F1, F2, F3 are shown in parallel to each other and leading from a grid power supply to a single load, such as a generator or motor.

To accommodate applications with varying load or generator conditions, the operational frequency range of the circuit disconnection devices S1, S2, S3 is dynamically adjustable. This is particularly advantageous for marine applications where operating conditions can vary significantly due to changes in load demand, environmental factors, and generator output characteristics.

The system may also include an integrated diagnostic monitoring unit or system 10 that identifies, logs, and reports fault conditions, improving overall reliability. This diagnostic unit 10 may communicate with external monitoring systems, providing real-time updates and alerts for maintenance personnel. This feature significantly reduces unplanned downtime and allows for predictive maintenance strategies. This diagnostic unit 10 may be part of or connected to a controller 100 for controlling the protection system.

Further, the fuses F1, F2, F3 may be comprise or may be connected to temperature-sensitive elements to enhance protection under varying thermal conditions. The switches S1, S2, S3 are rated for the high-frequency switching used by the inverter to drive the motor, ensuring optimal performance. Additionally, the modular design allows for cost-effective scalability and weight reduction compared to conventional protection systems using a single switch and fuse.

The protection system described in this invention offers several key advantages. One of the main benefits is an enhanced redundancy inherent to the system. By allowing for the selective isolation of faulty converters, the system ensures that the overall power converter arrangement can continue operating without the need for a complete system shutdown. This significantly improves the reliability and availability of the system.

Another advantage is the simplified scalability of the system. Thanks to its modular design, the system can be expanded based on the number of converters in use. This makes it suitable for a wide range of applications, from small auxiliary power units to large marine propulsion systems. The modularity of the design also allows for easy upgrades and maintenance.

In terms of cost and weight, this invention provides a more economical alternative compared to traditional single-fuse protection systems. The use of fewer materials leads to reduced overall system weight and lower production costs. This makes the system more efficient and cost-effective, especially in industries where weight and cost are critical factors.

Improved thermal protection is another key feature of this system. The use of temperature-sensitive fuses and advanced thermal management techniques ensures that the system remains reliable under various environmental conditions. This is particularly important in applications where the system is exposed to fluctuating and/or critical temperatures.

The system also offers optimized fault response. The dynamic adjustment of protection settings allows the system to respond efficiently to different fault scenarios. This reduces the risk of unnecessary shutdowns and ensures that the system can continue operating even in the presence of faults.

Additionally, seamless integration with monitoring systems is a significant advantage. The diagnostic monitoring system enables real-time data logging and remote fault detection. This makes the system ideal for unmanned or automated power management applications. The ability to monitor the system remotely helps to minimize unplanned downtime, supports predictive maintenance strategies and reduced associated costs.

The present invention covers several aspects. Firstly, the modular architecture enables the independent isolation and/or replacement of faulty converters, enhancing the system's redundancy and reliability. The use of cascading fuses provides enhanced backup protection, ensuring that the system can continue operating even if one fuse fails.

The system is also capable of operating at non-standard synchronous generator frequencies, which makes it versatile and adaptable to different power generation environments. The integration of diagnostic monitoring improves fault detection and reporting, allowing for timely maintenance and repair.

Another key feature is the prioritization of converter isolation based on fault severity. This ensures that the most critical faults are addressed first, minimizing the impact on the overall system. The dynamic adjustability of the circuit disconnection devices allows the system to adapt to varying operational conditions, enhancing its flexibility and performance.

The invention further provides cost and weight advantages of the distributed protection approach over traditional single-device systems. The use of temperature-sensitive fuses for enhanced thermal protection ensures that the system can withstand a wide range of environmental conditions.

The compatibility of the system with marine-class switches and fuses reduces overall implementation costs, making it an economical solution for marine and offshore applications.

The invention is particularly suitable for marine electric propulsion systems, offshore power generation, and industrial applications that require high reliability and redundancy in the protection of synchronous motors and generators. The system's ability to selectively isolate faults while maintaining overall operation ensures increased uptime and improved performance in mission-critical environments. These environments include commercial shipping, offshore platforms, and renewable energy systems, where reliability and continuous operation are of utmost importance.

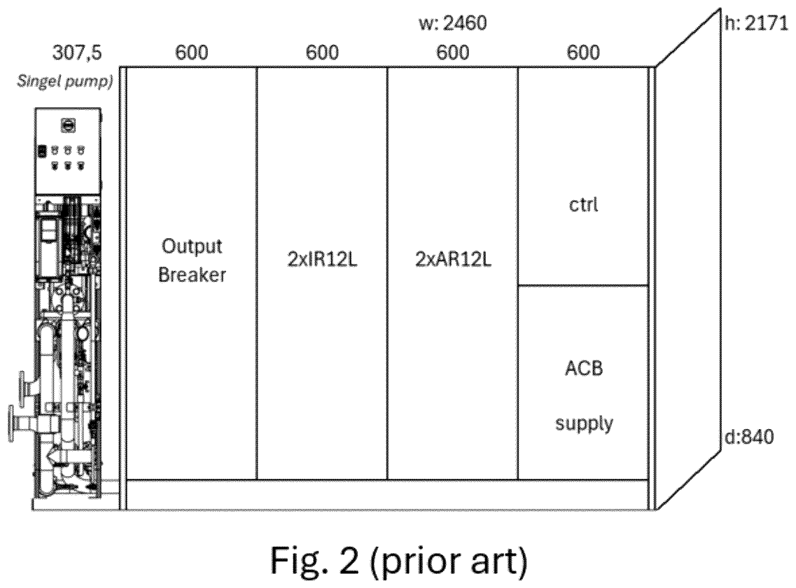

FIG. 2 is a schematic diagram of a power converter arrangement according to the state of the art. Here, a single output breaker is shown as a single circuit disconnection device. In case a fault occurs, the entire converter arrangement has to be disconnected from the grid via the output breaker.

The numbers given in FIG. 2 indicate typical dimensions of the power converter arrangement, denoted in millimeters and referring to the width w, height h, and depth d of the arrangement. The output breaker may function as the present invention's disconnection device (S1, S2, S3). 2xIR12L indicates a dual output inverter unit with an integration rack. 2xAR12L indicates a dual Active Front End inverter unit. Ctrl indicates a control section compartment which may comprise the controller 100. ACB supply indicates an air circuit breaker connection for supplying a grid connection.

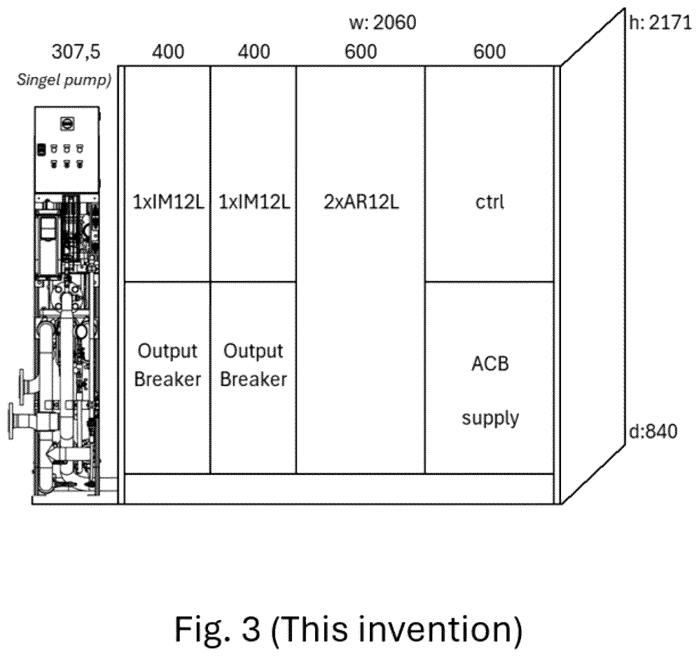

FIG. 3 is a schematic diagram of a power converter arrangement according to the present invention. Here, two output breakers are provided as circuit disconnection devices, such that two converters of the arrangement can be disconnected from the grid can be disconnected independently.

The numbers given in FIG. 3 again indicate typical dimensions of the power converter arrangement, denoted in millimeters and referring to the width w, height h, and depth d of the arrangement. The two output breakers may function as the present invention's disconnection device S1, S2, S3. 2x1xIM12L indicates a single output inverter unit. 2xAR12L indicates a dual Active Front End inverter unit. Ctrl indicates a control section compartment which may comprise the controller 100. ACB supply indicates an air circuit breaker connection for supplying a grid connection.

While the present disclosure has been illustrated and described and with respect to a particular embodiment thereof, it should be appreciated by those of ordinary skill in the art that various modifications to this disclosure may be made without departing from the spirit and scope of the present disclosure.

What is claimed is:

1. A protection system for a synchronous generator or motor in a power converter arrangement with a controller and at least two converters, comprising:
a plurality of circuit disconnection devices each configured to interrupt the power supply to one converter,
a fault detection device, such as a current sensor and/or or fuses for detecting faults of the converters,
wherein the controller triggers a remote open signal to at least one of the circuit disconnection devices for interrupting the power supply to a converter upon detection of a fault condition, wherein each disconnection device operates independently to interrupt the power supply of a faulty converter, enabling continued operation of the remaining converters.

2. The protection system according to claim 1, further comprising:
a plurality of fuses each associated with a respective circuit disconnection device
the fuses being configured to provide cascading backup protection specifically for fault conditions where the operational frequency is outside the rated range of the circuit disconnection devices

3. The protection system according to claim 1, wherein the fuses and circuit disconnection devices are configured to provide fault protection for frequencies other than the standard 50/60 Hz, enabling effective protection in applications with non-standard synchronous generator or motor frequencies.

4. The protection system according to claim 1, wherein the individual isolation of converters facilitates enhanced redundancy by allowing the system to continue operation with unaffected converters when a fault is detected and a converter is isolated.

5. The protection system according to claim 1, wherein the fuses and circuit disconnection devices are sized and selected to optimize protection for systems with limited short circuit power supply availability, reducing the risk of overloading protection devices.

6. The protection system according to claim 1, wherein the operational frequency range of the circuit disconnection devices is dynamically adjustable to accommodate varying load or generator conditions.

7. The protection system according to claim 1, wherein the remote open signal prioritizes isolation of converters based on severity or type of fault.

8. The protection system according to claim 1, wherein the circuit disconnection devices and/or fuses are designed as modular units, allowing scalable protection for systems with varying numbers of converters.

9. The protection Protection system according to claim 1, wherein the fuses include temperature-sensitive elements to enhance protection under varying thermal conditions.

10. The protection system according to claim 1, further comprising an integrated diagnostic monitoring system to identify, log, and report fault conditions and isolation events.

11. The protection system according to claim 1, wherein the fuses are rated for a lower current than the summary synchronous generator or motor current.

12. The protection system according to claim 1, wherein the circuit disconnection devices are rated for a lower current than the summary synchronous generator or motor current.

13. The protection system according to claim 1, wherein the fuses are faster to interrupt the current than one single fuse to lead the total current would be.

14. The protection system according to claim 1, wherein the switches are rated for the high frequency switching used by the inverter to drive the motor.

15. The protection system according to claim 1, wherein the circuit disconnection devices and/or fuses are cheaper to use than a system with a single switch and/or a single fuse.

16. The protection system according to claims claim 1, wherein the circuit disconnection devices and/or fuses have a lower total weight than a system with a single switch and/or a single fuse.

17. A power system comprising:
a bi-directional DC-link configured to facilitate power transfer between a power supply and a load,
a protection system according to claim 1, wherein the protection system ensures safe operation of the DC-link during fault conditions.
